(19) United States
(12) Patent Application Publication
(10) Pub. No.: US 2015/0208668 A1
(43) Pub. Date: Jul. 30, 2015

(54) COMPOSITION FOR CONTROLLED RELEASE AND METHOD FOR MANUFACTURING THE SAME

(71) Applicant: Borhan Chueh, Mountain View, CA (US)

(72) Inventor: Borhan Chueh, Mountain View, CA (US)

(73) Assignee: Borhan Chueh, Mountain View, CA (US)

(21) Appl. No.: 14/603,708

(22) Filed: Jan. 23, 2015

Related U.S. Application Data
(63) Continuation of application No. 61/933,675, filed on Jan. 30, 2014, now abandoned.

(51) Int. Cl. A01N 65/28

(52) U.S. Cl. CPC A01N 65/28

(57) ABSTRACT

A method for manufacturing a composition for controlled release including multiple steps is provided. Firstly, an inclusion and a polymer aqueous solution are provided. The polymer aqueous solution has weight percentage ranging from 0.4% to 2%. Then, the inclusion is mixed with the polymer aqueous solution well so as to form a mixture; a molding process is performed on the mixture to form a plurality of colloids. Next, a cross-linking process is performed to conduct a reaction between the colloids and an aqueous solution having divalent metal ion so as to form a plurality of reticular structures. Finally, a drying process is performed on the reticular structures. A composition for controlled release is also provided.

### CROSS-REFERENCE TO RELATED APPLICATION

This application claims the benefit of U.S. Provisional Application No. 61/933,675, filed on Jan. 30, 2014 in the United State Patent and Trademark Office, the disclosure of which is incorporated herein by reference.

### BACKGROUND OF THE INVENTION

1. Field of the Invention

The present invention generally relates to composition for controlled release and method for manufacturing the same.

2. Description of the Related Art

Recently, it is found that controlled release system or sustained release system is better than dump system in pharmaceuticals, cosmetics and personal skincare, food sciences, and agriculture. There are six categories about controlled release systems: Diffusion-Control System, Matrix Diffusion System, Swelling-Controlled System, Erosion-Controlled System, Chemically-Controlled System, and Osmotic Pumps System.

However, the above-mentioned conventional technology cannot achieve long-term releasing of inclusions stably like the present invention. In addition, the thickness of capsule shell is difficult to composite during manufacturing. In other words, this invention is to manufacture a composition for achieve releasing inclusions stably and conserving activity of the inclusions.

The above information disclosed in this Background section is only for enhancement of understanding of the background of the described technology and therefore it may contain information that does not form the prior art that is already known to a person of ordinary skill in the art.

### SUMMARY OF THE INVENTION

The primary objective of the present invention is to provide a method for manufacturing a composition for controlled release including multiple steps is provided.

Therefore, to achieve the foregoing objective, the present invention provides a method for manufacturing a composition for controlled release, comprising the following steps: (a) utilizing an inclusion and a polymer aqueous solution, wherein the weight percentage ranging from 0.4% to 2%; (b) mixing the inclusion and the polymer aqueous solution to form a mixture; (c) molding the mixture to form a plurality of colloids; (d) cross-linking by adding an aqueous solution of divalent metal ions to colloids to form reticular structures, and (e) drying of the reticular structures.

The following description of the drawing and examples are presented in order to allow for a more thorough understanding of the subject matter and experimental procedure of the present invention. The drawing and examples are meant to illustrate the embodiments of the present invention, and are not to be construed as limiting the scope of the invention.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a flow diagram of manufacturing a composition for controlled release;

FIG. 2A illustrates an inclusion and a polymer aqueous solution in different containers.

FIG. 2B illustrates the mixing process of manufacturing a composition for controlled release.

FIG. 2C illustrates the molding process to manufacture the composition for controlled release.

FIG. 2D illustrates the addition of aqueous solution of divalent metal ions to the composition for controlled release.

FIG. 2E illustrates the drying process to manufacture the composition for controlled release.

FIG. 3 illustrates the partial microscopic schematic diagram for cross-linking in the composition for controlled release

### DETAILED DESCRIPTION OF THE PREFERRED EMBODIMENTS

Details of the objects, technical configuration, and effects of the present invention will be described more fully hereinafter with reference to the accompanying drawings, in which exemplary embodiments of the invention are shown. The like reference numerals indicate the like configuration throughout the specification, and in the drawings, the length and thickness of layers and regions may be exaggerated for clarity. The technical content of the present invention will become apparent by the detailed description of the following embodiments and the illustration of related drawings as follows. As used herein, the term “and/or” includes any and all combinations of one or more of the associated listed items.

Various embodiments will now be described more fully with reference to the accompanying drawings, in which illustrative embodiments are shown. The inventive concept, however, may be embodied in various different forms, and should not be construed as being limited only to the illustrated embodiments. Rather, these embodiments are provided as examples, to convey the inventive concept to one skilled in the art. Accordingly, known processes, elements, and techniques are not described with respect to some of the embodiments.

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art.

One of object of the present invention is to provide a method for manufacturing a composition for controlled release. The process is described thereafter.

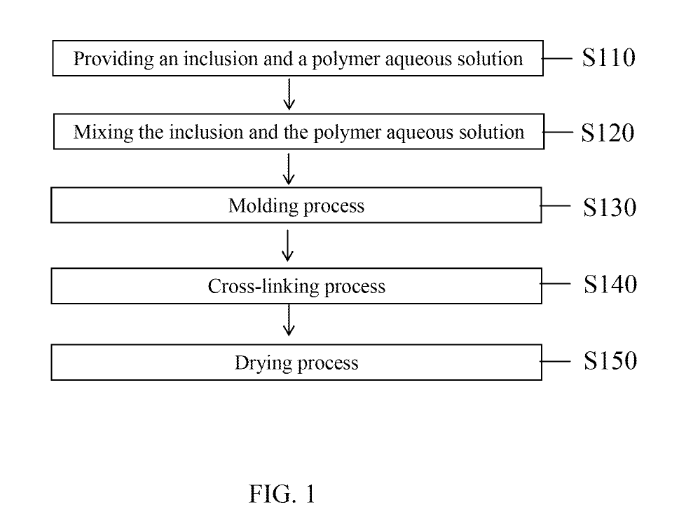

With reference to FIG. 1, a flow diagram of manufacturing a composition for controlled release is illustrated. A method for manufacturing a composition for controlled release comprises the following steps: (S110) utilizing an inclusion and a polymer aqueous solution, wherein the weight percentage ranging from 0.4% to 2%; (S120) mixing the inclusion and the polymer aqueous solution to form a mixture; (S130) molding the mixture to form a plurality of colloids; (S140) cross-linking by the addition of an aqueous solution of divalent metal ions to the colloids to form reticular structures, and (S150) drying of the reticular structures.

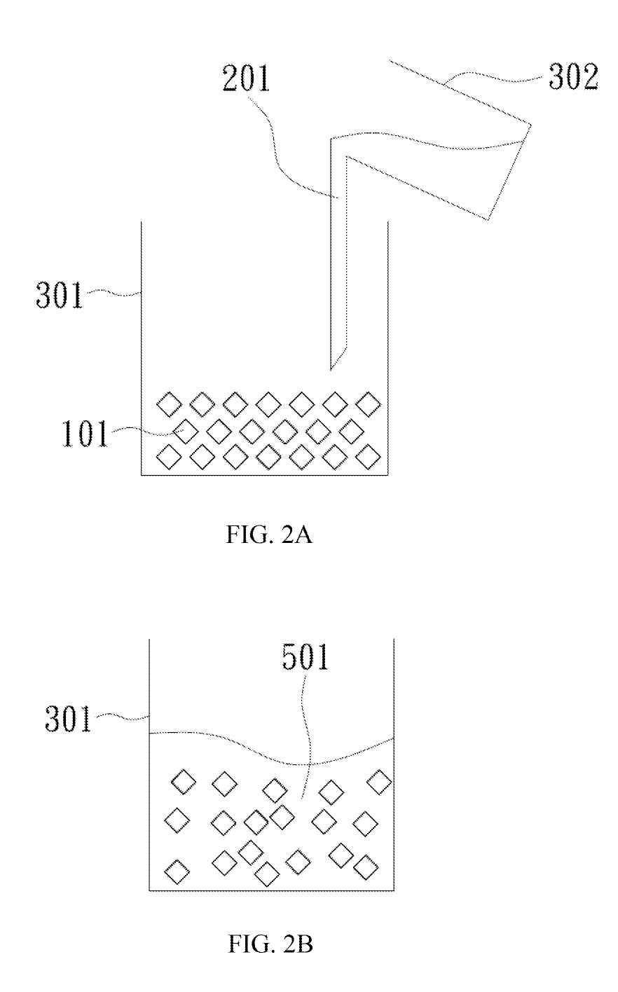

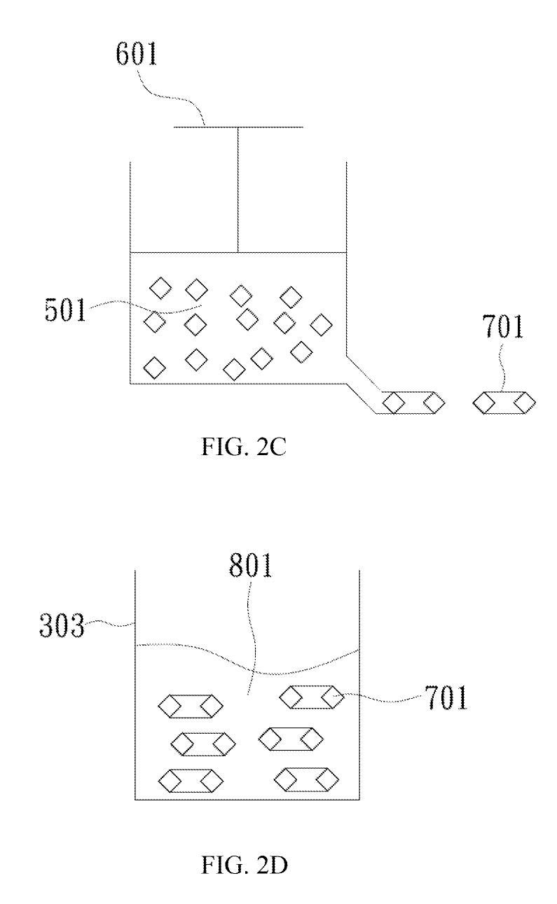

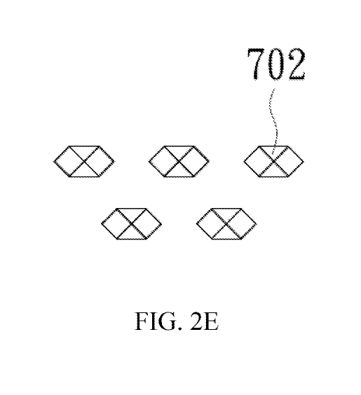

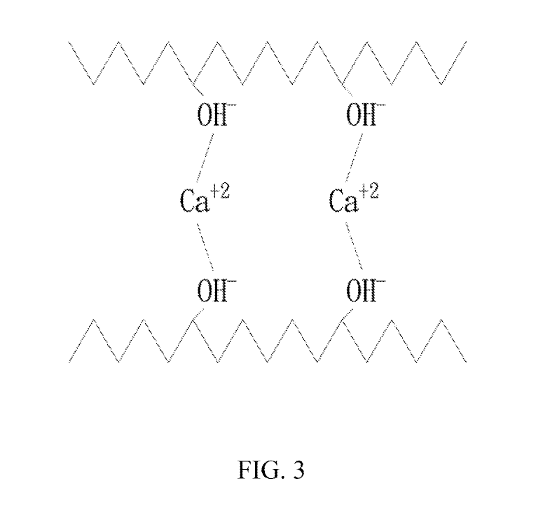

With reference to FIG. 1 and FIG. 2A, the manufacturing of a composition of controlled release are illustrated. In this invention, STEP S110 provides an inclusion 101 and a polymer aqueous solution 201. The inclusion 101 can be plant extracts, probiotics, such as lactobacillus, yeasts, polysaccharides, fat, proteins, saponins, medicines, organic compounds, bio-extracts or combinations thereof. The size of the inclusion 101 can be on the order of micrometer to nanometer. The inclusion 101 can be in liquid or in solid form. The polymer aqueous solution 201 can be prepared from plant-extract polymers such as an alginate extract aqueous solution or chemical-synthesized polymers. The inclusion 101 and the polymer aqueous solution 201 can be placed in containers 301 and 302 such as beakers or graduates.

With reference to FIG. 1 and FIG. 2B, the manufacturing of a composition of controlled release are illustrated. In this invention, STEP S120 mixes an inclusion 101 and a polymer aqueous solution 201 to form a mixture 501 in a container 301. The mixing process can be manually stirred by a stirring stick or automatically stirred by a homogenizer, an ultrasonic oscillator or a cell disruptor. The volume ratio of the inclusion 101 and the polymer aqueous solution 201 ranges from ⅛-4, preferably ¼-2. It should be noted that, if weight percentage of the polymer aqueous solution above 4%, the polymer aqueous solution would be too dense to stir. Thus, the inclusion 101 cannot be evenly dispersed in the polymer aqueous solution 201.

In this preferred embodiment, pH value of the polymer aqueous solution 201 may be ranging from 4 to 10. Furthermore, different inclusions have its optimal pH environment. For instance, yeast extract prefers pH 5.5.

With reference to FIG. 1 and FIG. 2C, the manufacturing of the composition of controlled release are illustrated. In this invention, STEP S130 is molding a mixture 501 and forms a plurality of colloids 701. Referring to FIG. 2C, the mixture 501 is transferred from a container 301 and compressed by a compressor 601. The mixture 501 forms the plurality of colloids 701 through an exit of the compressor 601. In the preferred embodiment, the compressor 601 can be automated machine or a manual operated tool such as an extruder, a syringe, a titration tube, a pipette, or cake-decorating tool. If users need large size of the colloids 701, the size of the colloids 701 can be adjusted through this molding process by the compressor 601. For instance, the compressor 601 has a large opening to exit.

With reference to FIG. 1 and FIG. 2D, the manufacturing of the composition of controlled release are illustrated. In this invention, STEP S140 is cross-linking by adding an aqueous solution of divalent metal ions 801 to colloids 701 to form reticular structures by cross-linking reaction. Referring to FIG. 2D, the aqueous solution having divalent metal ion 801 is placed in a container 303 and place the colloids 701 into the aqueous solution 801. Or the colloids 701 are placed in a container and the aqueous solution having divalent metal ion 801 is poured into the container (not shown). Furthermore, spray of the aqueous solution having divalent metal ion 801 to the surface of the colloids 701 can also result in the cross-linking reaction (not shown). The cross-linking mainly occurs on the surface of the colloids 701 not inside of the colloids 701 by spraying of the aqueous solution 801. Thus, this leads to fast release of a composition for controlled release.

In the preferred embodiment, the divalent metal ions in the aqueous metal solution 801 is Be²⁺, Ma²⁺, Ca CS²⁺, Ba²⁺ or combinations thereof. The equivalent concentration of the aqueous solution having divalent metal ion 801 is from 0.05-5N.

When the colloids 701 contact with the aqueous solution with divalent metal ion 801, the cross-linking reaction occurs shown in FIG. 3. The colloids 701 having a polymer aqueous solution 201 such as alginate extract have hydroxyl groups. This hydroxyl group and divalent metal ion such as calcium ion form an ionic bond and the colloids 701 become a reticular structure 702 shown in FIG. 2E. The inclusion 101 is encapsulated inside the reticular structure 702 or on the reticular structure 702. In addition, the degree of cross-linking can be adjusted by different divalent metal ion. Ba²⁺ has higher degree of cross-linking than Ca²⁺ and Cs²⁺.

With reference to FIG. 1 and FIG. 2E, the manufacturing of the composition of controlled release are illustrated. In this invention, STEP S150 dries the reticular structure 702 and forms the composition for controlled release. The drying process can be air-drying or freeze-drying of the reticular structure 702. If users need to shorten the drying process, then forced air current generated from a fan or heat from a heater may be applied (not shown). If a heater is used for drying the reticular structure 702, the heating temperature should not be higher than 120° C. High temperature environment may reduce the activity of the inclusion 101, such as probiotics. In addition, high temperature environment may only dry the surface of the reticular structure 702 but not the inside of the reticular structure 702. This results in the reticular structure 702 becoming fragile.

In this preferred embodiment of the present invention, the drying process step S150 may increase the storage period of the composition for controlled release.

In addition, the degree of cross-linking of a reticular structure 702 can be determined by Step S140 where cross-linking between colloids 701 and aqueous divalent metal ion solution 801 occurs. For example, the following two scenarios have the same concentration of the polymer aqueous solution 201 to form the colloid 701. If time for cross-linking is shorter within 5 min, the reticular structure 702 of the composition for controlled release will be thinner. On the contrary, if time for cross-linking is longer, such as 5 min-20 min, the condensed reticular structure 702 of the composition for controlled release will be formed. The former with thinner reticular structure 702 releases the inclusions 101 sooner; the later with condensed reticular structure 702 releases the inclusions 101 slower. In addition, the degree of cross-linking of the reticular structure 702 can be determined by the concentration of the polymer aqueous solution 201. For examples, if the colloid 701 is formed from high concentration of the polymer aqueous solution 201, time for cross-linking between the colloid 701 and the aqueous solution having divalent ions 801 can be shorten to form the reticular structure 702. On the contrary, if the colloid 701 is formed from low concentration of the polymer aqueous solution 201, time for cross-linking needs to increase to form the reticular structure 702.

The present invention further provides another method for manufacturing a composition for controlled release. The major difference for manufacturing the composition for controlled release is addition of a surfactant (not shown). For examples, the surfactant can be added into a polymer aqueous solution 201 or an inclusion 101 before the mixing step S120. The surfactant can also be added into a mixture 501 before the molding step S130. Preferably, the surfactant is a non-ionic surfactant or an anionic surfactant. In the preferred embodiment, the anionic surfactant is a phospholipid such as phosphatidyl choline, phosphatidyl ethanolamine or phosphatidyl inositol. Furthermore, an alginate extract aqueous solution is hydrophilic. If the inclusion 101 is hydrophobic, the surfactant can used to increase the stability between the alginate extract aqueous solution and the inclusion 101.

In agriculture, ampullariidae, or common name the apple snail, becomes a serious threat to rice production because rice seedling is an attractive food source for the snails. Tea tree powder having saponins can damage mucus secretion system of the apple snail and could be used as an organic pesticide in rice farms. However, the tea tree powder would often be prematurely removed by water irrigation or rain in the rice farm after farmers had sprayed the tea tree powder. Consequently, farmers would need to continuously spray tea tree powder in order to prevent the apple snails from eating rice seedlings. Therefore, if the tea tree powder could be released in a controlled fashion in a long-term period, a significant reduction in labor to consistently spray tea tree powder to prevent the growth of apple snails could be achieved.

In the preferred embodiment of the present invention, compositions of tea tree powder for controlled release comprises following steps: (S110) utilizing tea tree powder as an inclusion and an alginate extract polymer aqueous solution, wherein the weight percentage ranging from 0.6% to 1.5%, preferably 0.65%; (S120) mixing the tea tree powder and the polymer aqueous solution to form a mixture; (S130) molding the mixture to form a plurality of colloids; (S140) cross-linking by adding an aqueous solution of divalent metal ions to the colloids to form reticular structures, wherein time for cross-linking is 1 minute, and (S150) drying of the reticular structures. Two experiments: experimental group (2 kg composition of tea tree powder for controlled release) and control group (5 kg tea tree powder) were conducted in two different rice farms with the same size (0.1 Hectare). In order to study release of the tea tree power, chemical oxygen demand (COD) was measured from the experimental group and the control group on Day 14, Day 21 and Day 27.

Please refer to the following table 1:

TABLE 1

| No. | Sampling | Group | COD (mg/L) | Loss (%) |
|---|---|---|---|---|
| 1 | Day 14 | Experimental | 55.4 | 0 |
| | | Control | 13.8 | 0 |
| 2 | Day 21 | Experimental | 51.7 | 6.68% |
| | | Control | 19.6 | −42.03% |
| 3 | Day 27 | Experimental | 38.3 | 25.92% |
| | | Control | 7.2 | 63.27% |

With reference of Table 1, CODs from experimental group were higher than CODs from control group. CODs from the experimental group were gradually decreased, compared to the control group. This suggests that the compositions of tea tree powder for controlled release can slowly release the tea tree powder in rice farms.

Furthermore, to enable any person skilled in the art to understand the characteristics the composition for controlled release, the embodiments and the technical principles used are described above. However, these uses are merely exemplary, but not restricted. All variations and modifications of the present invention and the uses thereof are included in the scope of the present invention if they do not depart from the spirit of the disclosure of this specification and drawings. Any limitations for the scope of the present invention should be defined by the appended claims and their equivalents.

What is claimed is:

1. A method for manufacturing a composition for controlled release, comprising the following steps:
(a) utilizing an inclusion and a polymer aqueous solution, wherein weight percentage ranging from 0.4% to 2%;
(b) mixing the inclusion and the polymer aqueous solution to form a mixture;
(c) molding the mixture to form a plurality of colloids;
(d) cross-linking by adding an aqueous solution of divalent metal ions to the colloids to form reticular structures, and
(e) drying of the reticular structures.

2. The method of claim 1, wherein the volume ratio of the inclusion and the polymer aqueous solution is between ⅛-4.

3. The method of claim 1, wherein the polymer aqueous solution is an alginate extract aqueous solution.

4. The method of claim 1, wherein the pH value of the polymer aqueous solution is ranging from 4-10.

5. The method of claim 1, wherein the divalent metal ion is Be²⁺, Mg²⁺, Ca²⁺, Cs²⁺, Ba²⁺ or combination thereof.

6. The method of claim 5, wherein equivalent concentration of the aqueous solution having divalent metal ion is ranging from 0.05-5N.

7. The method of claim 1, wherein the cross-linking is spraying aqueous solution having divalent metal ion on the surface of the colloids.

8. The method of claim 1, wherein the cross-linking is immersing the colloids into aqueous solution having divalent metal ion.

9. The method of claim 1, wherein the drying processing is using freeze-drying to dry the reticular structures.

10. The method of claim 1, wherein the drying processing is using heater with heating temperature below 120° C. to dry the reticular structures.

11. The method of claim 1, wherein the drying processing is using air-drying to dry the reticular structures.

12. The method of claim 1, wherein a surfactant is added before molding.

13. The method of claim 1, wherein the inclusion is plant extracts, probiotics, yeasts, polysaccharides, fat, proteins, saponins, medicines, organic compounds, bio-extracts or combinations thereof.

14. Compositions of controlled release comprise an inclusion, a polymer aqueous solution and divalent metal ion, wherein the inclusion is encapsulated inside of the reticular structure or on the reticular structure.

15. The method of claim 14, wherein the inclusion is plant extracts, probiotics, yeasts, polysaccharides, fat, proteins, saponins, medicines, organic compounds, bio-extracts or combinations thereof.

16. The method of claim 14, wherein the polymer aqueous solution is an alginate extract aqueous solution.

17. The method of claim 14, wherein the polymer aqueous solution is a chemical-synthesized polymer solution.

18. The method of claim 14, wherein the divalent metal ion is Be²⁺, Mg²⁺, Ca²⁺, Cs²⁺, Ba²⁺ or combination thereof.

19. The method of claim 14, wherein a surfactant is added.

20. The method of claim 14, wherein the surfactant is phosphatidyl choline, phosphatidyl ethanolamine or phosphatidyl inositol.
